(19) United States
(12) Patent Application Publication
(10) Pub. No.: US 2013/0279872 A1
(43) Pub. Date: Oct. 24, 2013

(54) RECORDING APPARATUS, IMAGING AND RECORDING APPARATUS, RECORDING METHOD, AND PROGRAM

(71) Applicant: SONY CORPORATION, Tokyo (JP)

(72) Inventors: Tsutomu Shimosato, Kanagawa (JP); Norio Wakatsuki, Kanagawa (JP)

(73) Assignee: Sony Corporation, Tokyo (JP)

(21) Appl. No.: 13/837,975

(22) Filed: Mar. 15, 2013

(30) Foreign Application Priority Data
Apr. 20, 2012 (JP) 2012-096968

(51) Int. Cl. H04N 9/79

(52) U.S. Cl. CPC H04N 9/79
USPC 386/224; 386/326

(57) ABSTRACT

A recording apparatus includes: a buffer unit that accumulates input stream data; a file recording processing unit that records a file of the stream data which is accumulated in the buffer unit and management information which is used to manage the file in a recording medium; a buffer monitoring unit that monitors a free space of the buffer unit; and a file system control unit that controls time that updates the management information using the file recording processing unit based on the free space of the buffer unit which is notified by the buffer monitoring unit.

### FIELD

The present disclosure relates to a recording apparatus which records data using a semiconductor memory or the like as a recording medium, an imaging and recording apparatus which includes the recording apparatus, a recording method which is applied to the recording apparatus and the imaging and recording apparatus, and a program which performs the recording method.

### BACKGROUND

As an imaging apparatus, such as a video camera, an imaging and recording apparatus which includes a recording function has been put to various practical uses. As the imaging and recording apparatus, in recent years, an apparatus which uses a memory card having a semiconductor memory as a recording medium has been developed with the spread of the semiconductor memory and its low cost.

A memory card is small and light compared to magnetic tapes and various types of disks which are used as recording media by an imaging and recording apparatus according to the related art. Therefore, using a memory card as a recording medium contributes to the downsizing of the imaging and recording apparatus. In addition, it is easy to mount and detach the memory card on and from a card slot which is provided in the main body of the imaging and recording apparatus.

When a semiconductor memory, such as a memory card, is used as a recording medium in a recording apparatus, such as a video camera, a process is performed as follows.

For example, when video data or the like is recorded in a semiconductor memory within the memory card which is mounted on the card slot of the imaging and recording apparatus, the video data which is captured and obtained by an imaging unit is sequentially supplied to the memory card, and recorded in the semiconductor memory within the memory card. Meanwhile, recording of data in the semiconductor memory is called storing or writing. However, in this specification, recording, storing, and writing are not specifically distinguished.

In the semiconductor memory, writing speed can be increased by writing and removing the amount of data in a determined unit. Accordingly, instead of the supplied video data being sequentially supplied to and recorded in the semiconductor memory without change, data are collected for each data in a determined unit (recording unit) and recorded in the semiconductor memory, and thus recording speed increases. In the semiconductor memory, a unit called a removal block corresponds to the recording unit.

Here, when the transmission rate of video data which is captured and obtained by an imaging and recording apparatus is high to some extent, generated video data reaches the amount of data in a recording unit at a relatively short interval, and the video data is sequentially transmitted to a recording media side and recorded in a semiconductor memory.

A rate of generation of video data which is obtained varies depending on an imaging condition or the like. For example, when an image in which the little variation in a subject is successively captured, the amount of data of video data which is generated decreases, and thus there is a case in which the rate of generation becomes low. In addition, even when imaging in which a frame period is considerably long is performed like intermittent capturing, there is a case in which a transmission rate becomes low.

JP-A-2008-35394 discloses an example of the configuration of an imaging apparatus which uses a semiconductor memory as a recording medium.

### SUMMARY

Incidentally, if an imaging operation is suddenly discontinued for some reason, the imaging and recording apparatus becomes a state in which data which does not reach the above-described recording unit from among the video data captured and obtained by the imaging unit is not recorded in the memory card.

In addition, even in a case of data which is recorded in the recording media, if the data is not reflected on the file management information of the recording media, the data is not treated as recorded data, and the recorded data is substantially lost, thereby causing a state in which the data is not recorded in the recording media.

In a normal video camera, when an operation to stop imaging is performed, a process to stop image capturing is performed in such a way that all the video data which is captured is recorded in the recording media and management information is updated to a corresponding data. In contrast, for example, if the supply of power to the imaging and recording apparatus suddenly stops or recording media is extracted when imaging is being performed, data which does not reach the recording unit or data in which management information is not updated is lost.

Generally, an apparatus, which treats the stream data (video data and audio data) of the imaging and recording apparatus or the like, includes a stream buffer (a buffer memory) which accumulates the stream data when management information is updated. When the management information of the recording media is updated to correspond to the stream data which is recorded in the recording media, the management information is updated at a specific time regardless of the free space of the stream buffer in the apparatus. When update information is updated in the recording media, the stream data is not written and stored in the stream buffer when the update is being performed. Until now, since it does not take time to update the management information, it is possible to complete the update before the stream buffer overflows.

However, in the use of low-speed recording media which takes time to update the management information, in a system which has a small stream buffer capacity, and in a format in which the amount of generation of the stream data is large, it is not possible to store all the stream data, which is generated when the update information is being updated, in the stream buffer, and thus buffer overflow may occur. For example, if the NAND flash memory generation advances, there is a tendency for the speed of a process of the recording media to be low. In particular, since random access performance becomes low, the time that is necessary to update file management information is extended. In a method according to the related art, stream is stored in the stream buffer until the update of the file management information ends. Therefore, if the speed of the recording media becomes low, buffer overflow occurs. When buffer overflow occurs, for example, it leads the frame of a clip which is recorded in the imaging and recording apparatus to be omitted or recording to stop. The clip (material) is a unit of video data having an arbitrary length, and means an Audio Visual (AV) material which is configured as a single file. There is a case in which audio and video are configured as separate files. It is possible to cut a clip by sections having predetermined lengths and to use separate clips, and it is possible to divide the clip and use clips obtained through the division (or materials obtained through division).

It is therefore desirable to update management information in a recording medium without generating the buffer overflow of a stream buffer.

According to an embodiment of the present disclosure, input stream data is accumulated in a buffer unit, and the buffer monitoring unit monitors the free space of the buffer unit. Further, the file system control unit controls time to update the management information about a file which is recorded in a recording medium based on the free space of the buffer unit which is notified by the buffer monitoring unit.

According to the above configuration, the time to update the management information is controlled based on the free space of the buffer unit. Therefore, the management information may be updated after sufficient free space is secured in the buffer unit.

The embodiment of the present disclosure provides an advantage that it is possible to update the management information in the recording medium without generating the buffer overflow of the buffer unit.

### BRIEF DESCRIPTION OF THE DRAWINGS

FIG. 1 is a block diagram illustrating an example of the configuration of an imaging apparatus according to an embodiment of the present disclosure;

FIG. 2 is a block diagram illustrating an example of the configuration of data recording according to the embodiment of the present disclosure;

FIG. 3 is an explanatory view illustrating an example of a data recording unit according to the embodiment of the present disclosure;

FIG. 4 is a flowchart illustrating an example of a writing process according to the embodiment of the present disclosure;

FIG. 5 is a flowchart illustrating an example of a process to generate writing history information data according to the embodiment of the present disclosure;

FIGS. 6A to 6D are explanatory views illustrating examples of data recording states (processes when reservation is made) according to the embodiment of the present disclosure;

FIGS. 7A to 7D are explanatory views illustrating examples of the data recording states (states in which data corresponding to a single writing unit is input) according to the embodiment of the present disclosure;

FIGS. 8A to 8D are explanatory views illustrating examples of the data recording states (generation of the writing history information) according to the embodiment of the present disclosure;

FIGS. 9A to 9D are explanatory views illustrating examples of the data recording states (writing from a media buffer) according to the embodiment of the present disclosure;

FIGS. 10A to 10D are explanatory views illustrating examples of the data recording states (examples in which an additional information file reaches a file arrangement unit) according to the embodiment of the present disclosure;

FIGS. 11A to 11D are explanatory views illustrating examples of data recording states (input to the media buffer in the second cycle) according to the embodiment of the present disclosure;

FIGS. 12A to 12D are explanatory views illustrating examples of data recording states (a process to perform writing from the media buffer in the second cycle) according to the embodiment of the present disclosure;

FIGS. 13A to 13B are explanatory views illustrating examples of division performed on management data (states in which management information is not recorded) according to the embodiment of the present disclosure;

FIGS. 14A to 14B are explanatory views illustrating examples of the data recording states (states in which the management information is recorded) according to the embodiment of the present disclosure;

FIG. 15 is a flowchart illustrating an example of a process to update file management information according to the embodiment of the present disclosure;

FIG. 16 is a view illustrating an example in which writing is performed on a recording medium when recording starts in cache recording according to the related art (before synchronization peak shift correspondence);

FIG. 17 is a view illustrating an example in which writing is performed on the recording medium when recording starts in the cache recording (after synchronization peak shift correspondence) according to the embodiment of the present disclosure;

FIG. 18 is a view illustrating an example in which writing is performed on the recording medium in media stride according to the related art (before synchronization peak shift correspondence); and

FIG. 19 is a view illustrating an example in which writing is performed on the recording medium in the media stride (after synchronization peak shift correspondence) according to the embodiment of the present disclosure.

### DETAILED DESCRIPTION

An embodiment of the present disclosure will be described in the following order:

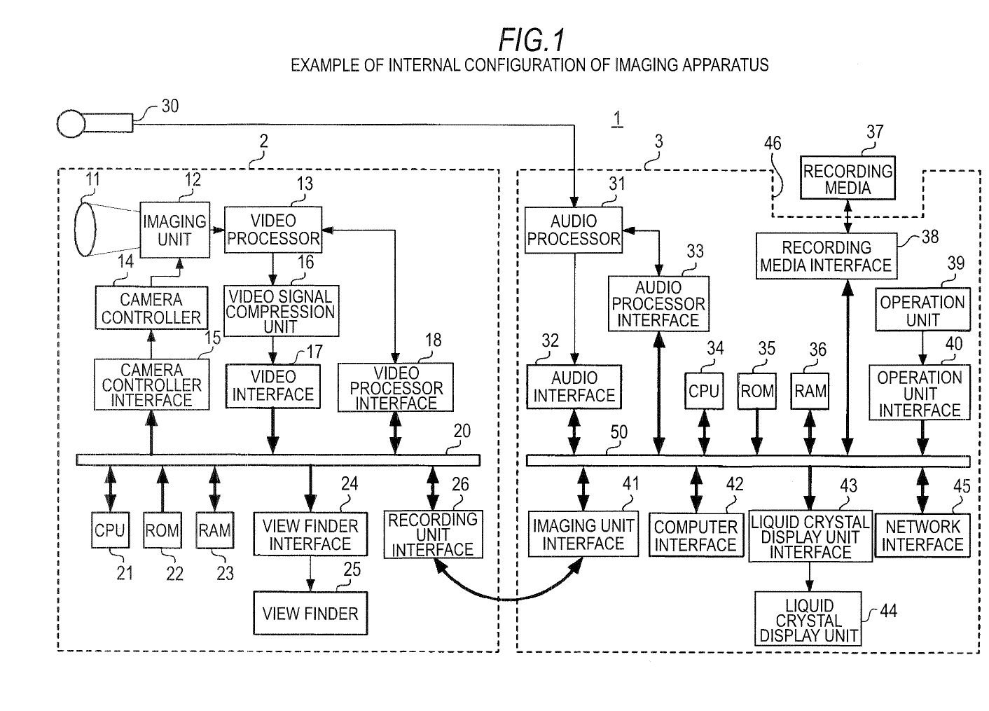

1. Example of Configuration of Entire Imaging Apparatus (FIG. 1)

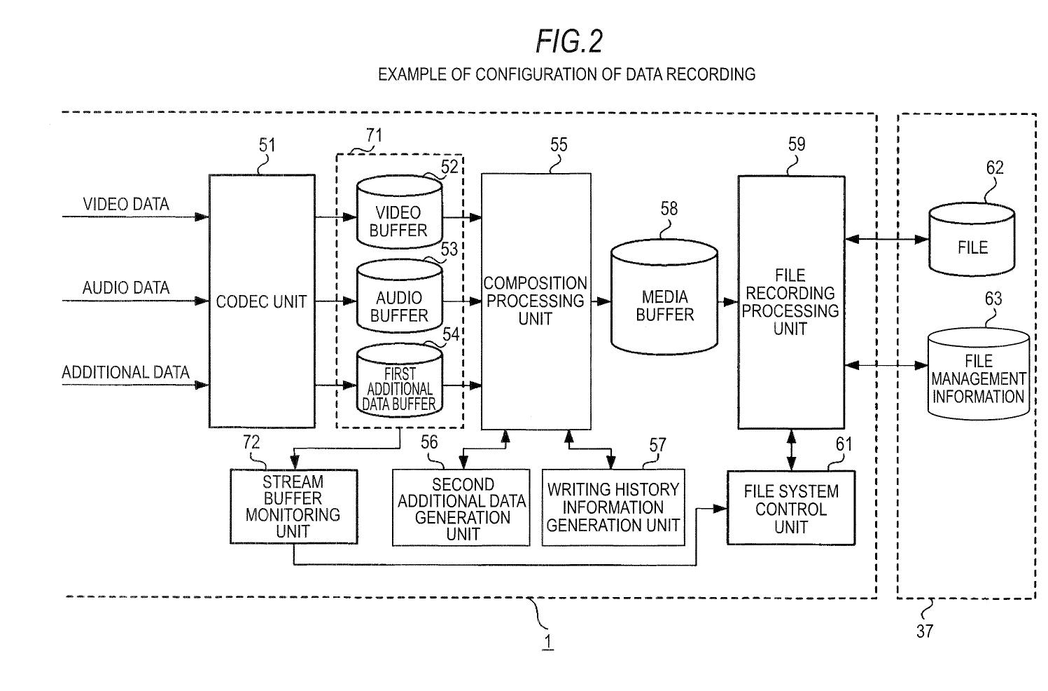

2. Example of Configuration of Data Recording Performed on Recording Medium (FIG. 2)

3. Description of Data Recording Unit (FIG. 3)

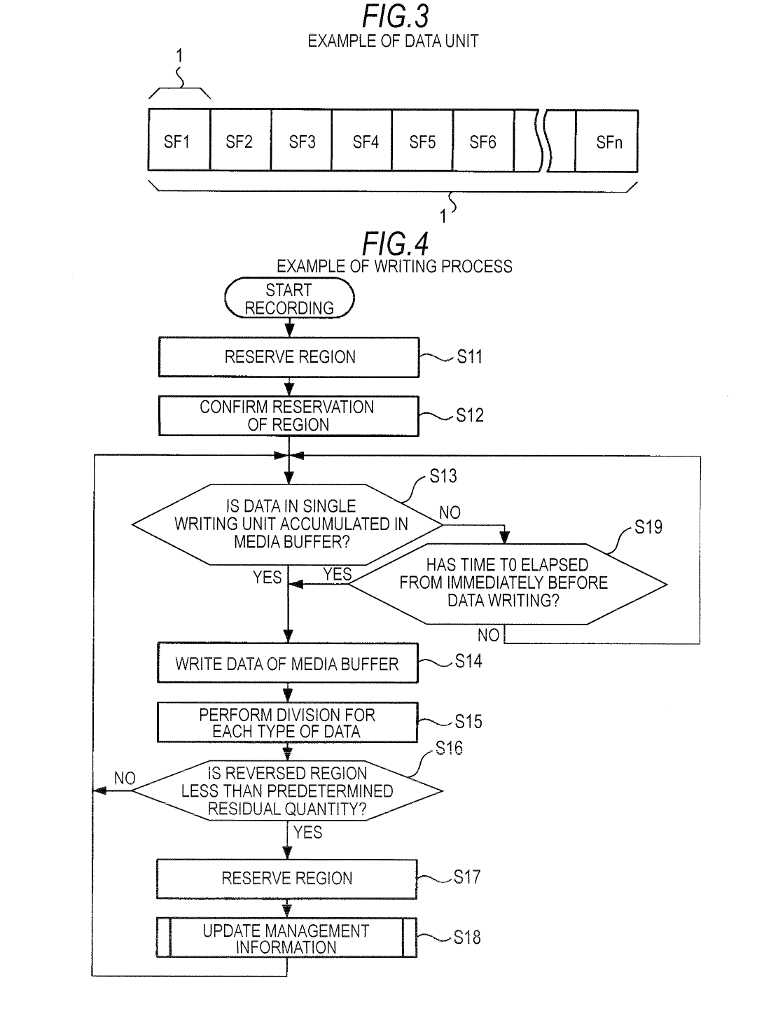

4. Operation of Data Recording Process (FIGS. 4 and 5)

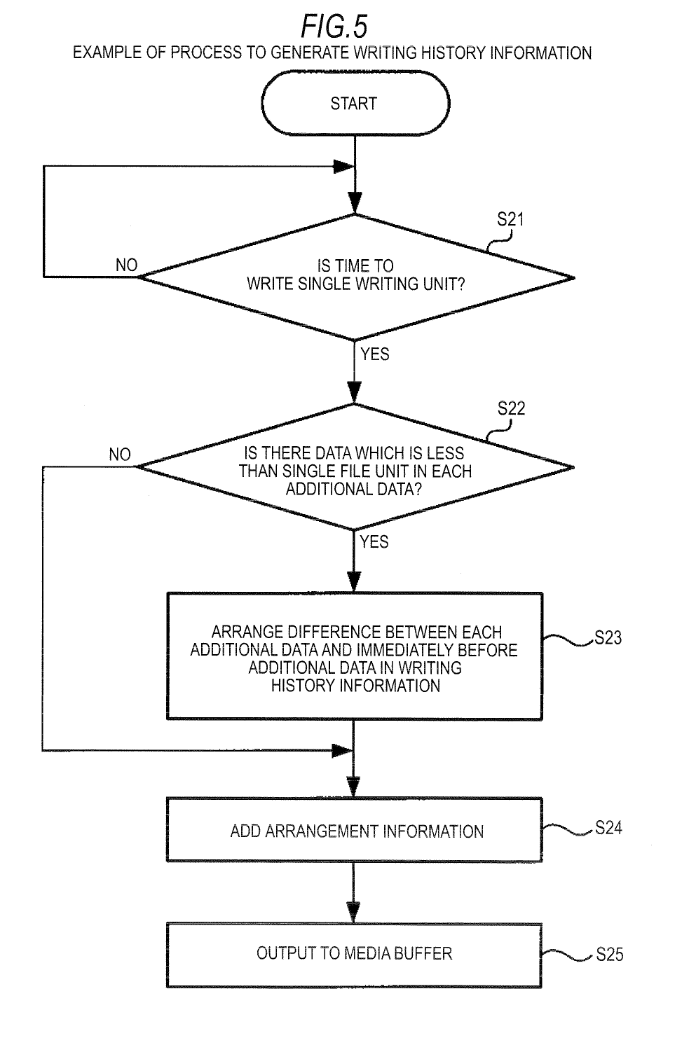

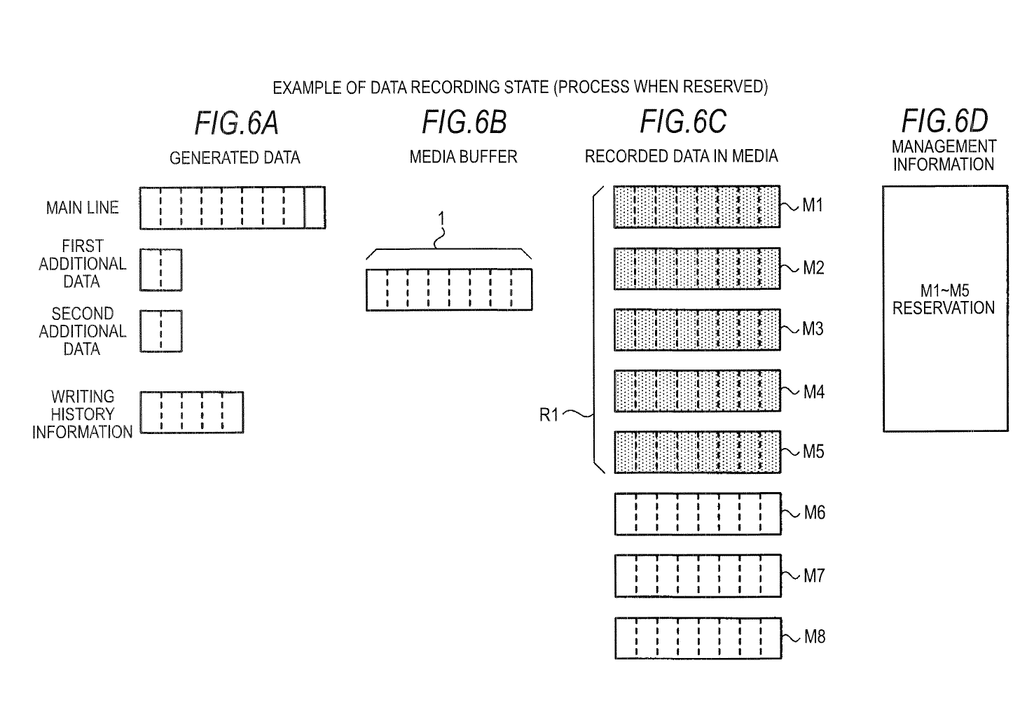

5. Detailed Example of Data Recording Operation (FIGS. 6A to 12D)

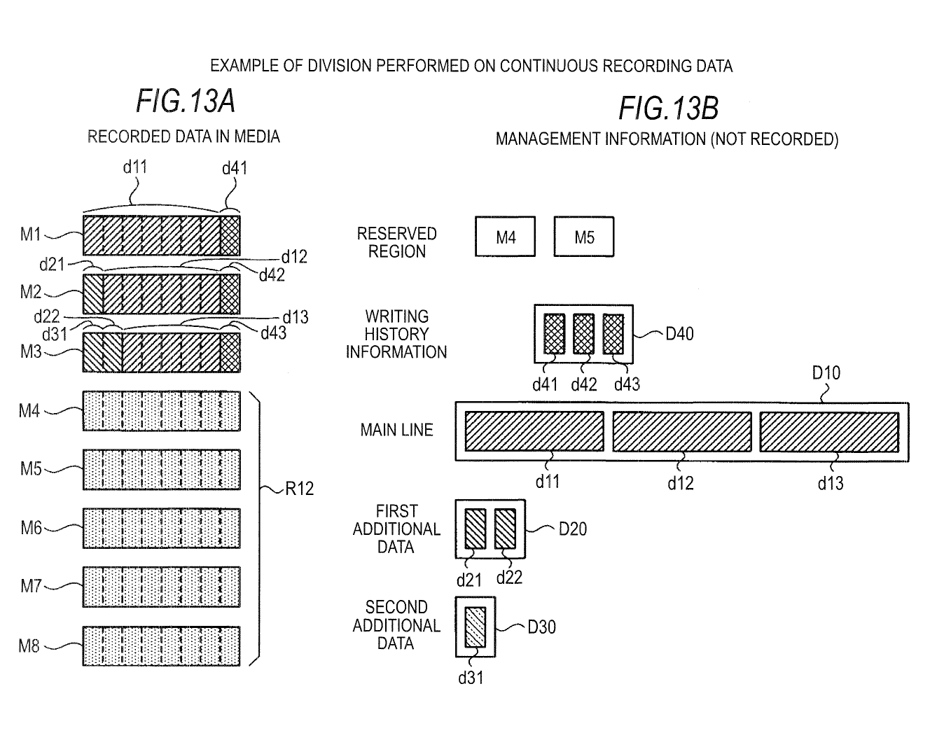

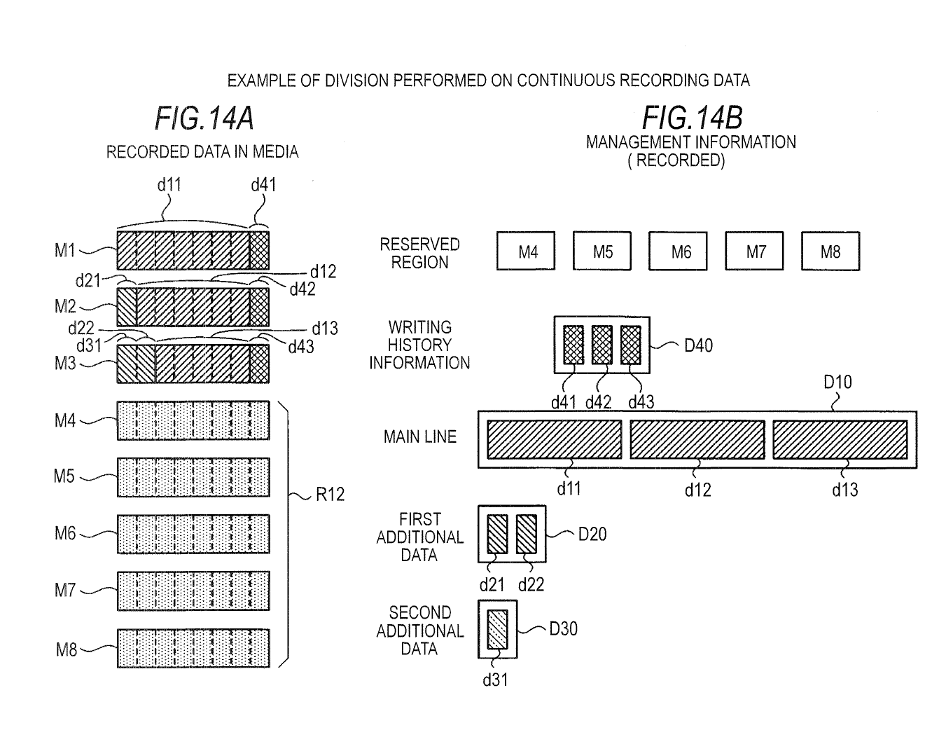

6. Example of Division Performed on Management Data (FIGS. 13A to 14B)

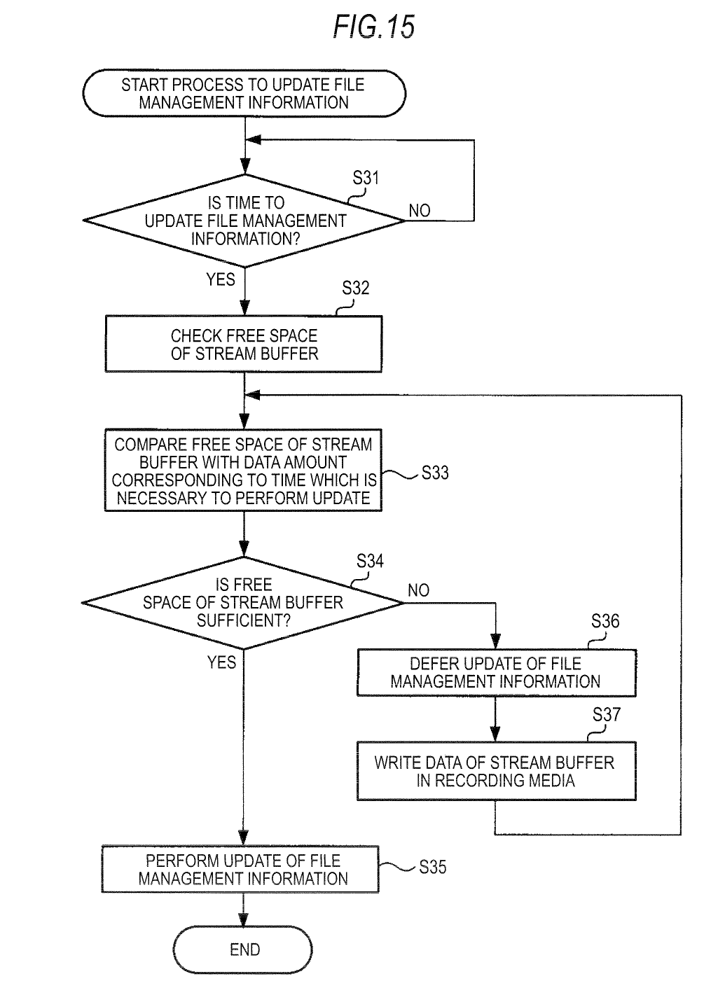

7. Example of Process to Update Management Information (FIGS. 15 to 19)

8. Modification Example

### [1. Example of Configuration of Entire Imaging Apparatus]

The embodiment will be described as an example which is applied to an imaging apparatus 1 capable of recording and reproducing images and sound using a memory card which is a detachable recording medium. Accordingly, although the imaging apparatus 1 is an imaging and recording apparatus or an imaging and recording and reproducing apparatus, which includes a recording function, the imaging apparatus 1 is simply described as an imaging apparatus here.

Meanwhile, a recording medium is called a recording medium in the embodiment. However, if the recording medium is provided with a semiconductor memory and is detachable, the recording medium is not necessary to have a card shape, and various types of produced memory apparatuses can be applied in addition to the memory card. A recording medium may be used in addition to the semiconductor memory. In the description hereinafter, a recording medium which is used in the embodiment is called a recording medium.

FIG. 1 is a block diagram illustrating an example of the internal configuration of the imaging apparatus 1 of the example. The imaging apparatus 1 controls a video camera, and includes an imaging unit 2 which generates video data, and a recording unit 3 which records video data, audio data, and metadata in a semiconductor memory, and reproduces the data when roughly classified.

First, each unit which configures the imaging unit 2 will be described. An imaging unit 12 performs photoelectric conversion on imaging light which is input via an optical unit 11 which includes a lens, a diaphragm, and a filter, and generates an analog video signal. The imaging unit 12 is configured with, for example, a solid state imaging device such as a Charge Coupled Device (CCD) imager. An imaging signal which is obtained by the imaging unit 12 is supplied to a video processor 13 which has an analog/digital conversion unit and an image adjustment function. The video processor 13 converts the supplied imaging signal into digital video data, and performs image adjustment. Thereafter, the video processor 13 supplies a digital video signal obtained through the conversion to a video signal compression unit 16 which compresses the digital video data using a predetermined method. The video signal compression unit 16 compresses and encodes the supplied digital video signal using a Moving Picture Experts Group (MPEG) method or the like. The video signal compression unit 16 supplies the compressed video data to a data bus 20 via a video interface 17. The compressed video data is supplied to the recording unit 3 via a recording unit interface 26 which will be described later, and is stored in a semiconductor memory within a recording medium 37 which will be described later. Each type of data which is used in the imaging unit 2 is transmitted to each unit via the data bus 20.

As a result of operation performed by a user using an operation unit 39 which will be described later, an operation signal is supplied to a central processing unit (CPU) 21 from the recording unit 3 via an imaging unit interface 41 which will be described later, the recording unit interface 26, and the data bus 20. The CPU 21 is a control device which controls the process of each unit within the imaging unit 2, and analyzes the supplied operation signal. When the operation signal is analyzed, the CPU 21 reads a control program from a ROM 22 during predetermined time, and temporarily stores temporary data and a parameter in a RAM 23. The Read Only Memory (ROM) 22 is a memory which can only be read, and the Random Access Memory (RAM) 23 is a memory which can be written.

The CPU 21 converts the operation signal which is supplied from the operation unit 39 into a control signal which drives the imaging unit 12, and supplies the control signal to a camera controller 14 via a camera controller interface 15. The camera controller 14 controls the zooming and filtering of the diaphragm of the imaging unit 12 based on the supplied control signal. In addition, the CPU 21 supplies an image process signal indicative of an image process to the video processor 13 via the video processor interface 18. The video processor 13 performs a digital video signal compression process based on the supplied image process signal.

The imaging unit 2 includes a view finder 25 which displays an image which is being captured, a reproduction image, and metadata. The image which is being captured, the reproduction image, and the metadata which are transmitted via the data bus 20 are displayed on the view finder 25 which includes a liquid crystal screen via a view finder interface 24.

Subsequently, each unit which configures the recording unit 3 will be described. A microphone 30, which directs toward the direction of a subject, collects surrounding sound, and generates analog audio data. The microphone 30 supplies an analog audio signal to an audio processor 31 which has an analog/digital conversion unit and a sound adjustment function. The audio processor 31 converts the supplied analog audio signal into digital audio data, and performs sound adjustment. Thereafter, the audio processor 31 supplies the digital audio data to a data bus 50 via the audio interface 32. The digital audio data is stored in the semiconductor memory within a recording medium 37 which will be described later. Each type of data which is used in the recording unit 3 is transmitted to each unit via the data bus 50.

The operation unit 39, which is configured with buttons and switches which are not shown in the drawing, is used for recording, reproducing, and editing operations performed by the imaging unit 2 and the recording unit 3. Depending on a manual operation, such as imaging start, the operation unit 39 generates the operation signal. The generated operation signal is supplied from the operation unit 39 to the CPU 34, which controls the process of each unit within the recording unit 3, via an operation unit interface 40 and the data bus 50. In addition, when the recording is performed, the operation signal is supplied to the imaging unit 2 via an imaging unit interface 41 which will be described later. Thereafter, a CPU 34 analyzes the supplied operation signal, reads the control program during predetermined time from a ROM 35 which can only be read, and temporarily stores the temporary data and the parameter in a RAM 36 which can be written.

The imaging apparatus 1 of the present example has a configuration in which the recording unit 3 includes a card slot 46 and the recording medium (memory card) 37 can be detachably mounted from the card slot 46. The recording medium is a recording medium which includes a built-in semiconductor memory. The recording state of data in the recording medium 37 will be described later.

The recording medium 37 which is mounted on the card slot 46 can exchange data with a data processing unit within the recording unit 3 via a recording medium interface 38.

Meanwhile, in the configuration in FIG. 1, although only a single card slot 46 is shown, the recording unit 3 may be configured to include a plurality of card slots. In addition to the recording medium 37 which is mounted on the card slot 46, the recording unit 3 may include a recording medium, such as a memory and a hard disk or the like, and may record the video data or the like.

In the recording unit 3, the imaging unit interface 41 is connected to the data bus 50 in order to exchange data with the imaging unit 2. The video data which is captured by the imaging unit 2 is supplied to and recorded in the recording medium 37 via the recording unit interface 26, the imaging unit interface 41, the data bus 50, and the recording medium interface 38. When the recording is performed, the CPU 34 functions as a recording control unit, and a control process to perform recording is executed.

The CPU 34 displays a monitor image, time code, an audio level, metadata, and various types of menus on a liquid crystal display unit 44, which includes a liquid crystal screen, via the data bus 50 and a liquid crystal display interface 43. The video data and audio data which are read from the recording medium 37 can be displayed as a video image which is reproduced by the liquid crystal display unit 44.

The imaging apparatus 1 includes a computer interface 42 which is used to exchange data with an external computer. The computer interface 42 is an interface in conformity to, for example, USB standard. The computer interface 42 can transmit data by connecting to an external computer apparatus which is not shown in the drawing, and can emit reproduced audio data by connecting to a speaker. In addition, the imaging apparatus 1 includes a network interface 45 which is used to exchange data via a network. The network interface 45 can transmit data by connecting to a server or an external computer apparatus, which is not shown in the drawing.

### [2. Example of Configuration of Data Recording Performed on Recording Medium]

Subsequently, a process configuration to record video data or the like in the recording medium 37 using the imaging apparatus 1 will be described with reference to FIG. 2.

FIG. 2 is a functional block diagram viewed from the flow of data which is recorded, and each process shown in FIG. 2 is performed using the video processor 13, the CPU 21, the CPU 34, the RAM 23, the RAM 36, and the like shown in FIG. 1.

In a case of the embodiment, when video data is recorded in the recording medium 37, it is supposed that a recording process is performed on an additional information file and writing history information, which are additional data, in addition to video data and audio data which are main data. The data of the additional information file is data (metadata) which accompanies the generation of video data such as time code or the like. These additional data is generated in a predetermined block within the imaging unit 2 or the recording unit 3, and input to the recording system of the recording unit 3. The time code is a code which indicates time at each frame position.

Meanwhile, in the description below, these additional data is divided into first additional data and second additional data which will be described later.

As shown in FIG. 2, the video data, the audio data, and the first additional data are supplied to a codec unit 51, and processes, such as compression and encoding, are respectively performed thereon for recording, and then the respective data are once accumulated in individual buffers. That is, a video buffer 52, an audio buffer 53, a first additional data buffer are provided, and input data are accumulated in the respective buffers 52, 53, and 54. For example, a ring buffer is used for each buffer. When these buffers are generically named or when the respective buffers are not distinguished, the buffers are called a stream buffer 71. The stream buffer 71 is an example of a buffer unit.

The data, which are accumulated in the respective buffers 52, 53, and 54, are supplied to a composition processing unit 55, composed into the data of a single system, and accumulated in a media buffer 58. The media buffer 58 is a device for storing the amount of data in a single recording unit, which is the amount of data recorded by one recording when recording is performed in the recording medium 37. In a case of the present example, the amount of data which is recorded in the recording medium 37 in one recording is the amount of data in a minimum unit when data is removed from the recording medium 37.

The composition processing unit 55 is connected to a second additional data generation unit 56 and a writing history information generation unit 57. The second additional data generation unit 56 generates data (second additional data) as a pointer which indicates the correspondence between the video data and the audio data, and inputs the generated data to the composition processing unit 55.

The writing history information generation unit 57 is a processing unit which generates the writing history information which is added whenever data in a single unit is recorded in the recording medium 37. Details of the writing history information will be described later.

The composition processing unit 55 composes generated second additional data and writing history information. Meanwhile, although not shown in the drawing, the second additional data is configured such that data which is generated in the second additional data generation unit 56 is accumulated in an internal buffer, and supplied to the composition processing unit 55 in a measurable data unit. The writing history information is generated whenever data in a single unit is recorded in the recording medium 37.

When recording data is supplied from the composition processing unit 55 to the media buffer 58 and the amount of data accumulated in the media buffer 58 is the amount of data in a single recording unit, the data is supplied from the media buffer 58 to a file recording processing unit 59 under the control of the CPU 34 which is a recording control unit. The data which is supplied to the file recording processing unit 59 is output to the recording medium 37, and recorded as a file 62 within the recording medium 37. The management data of the file 62 is recorded as file management information 63 in a separate region from the file 62. The data which is recorded as the file management information 63 and a recording operation are controlled by a file system control unit 61 which is connected to the file recording processing unit 59.

The imaging apparatus 1 includes a stream buffer monitoring unit 72 which regularly or periodically monitors the free space of the stream buffer 71, and notifies the file system control unit 61 of a result thereof. The stream buffer monitoring unit 72 is an example of a buffer monitoring unit. The file system control unit 61 controls, for example, time to update (update time interval) file management information 63, such as the delay of the time to update the file management information 63, based on information about the free space which is notified by the stream buffer monitoring unit 72.

Meanwhile, the data accumulated in the media buffer 58 is sequentially transmitted to the recording medium 37 from a top block, and recorded in the file 62 within the recording medium 37 in order of transmission.

### [3. Description of Data Recording Unit]

FIG. 3 is a view illustrating an outline of a unit in which data is recorded in the recording medium 37.

As shown in FIG. 3, a single writing unit (a single recording unit) is set using integral multiple of the capacity of a single file arrangement section (a single block). That is, the single file writing unit is configured with the arrangement of blocks SF1, SF2, . . . , SFn (n is an integer). Here, the single file writing unit coincides with the removal block unit of the semiconductor memory within the recording medium 37. The recording medium 37 which is used in the embodiment has a property in which high-speed access can be performed by performing access at single file arrangement intervals. The single file arrangement interval is configured with “a plurality of sector units” which is integral multiple of the capacity of a “single sector” which is a minimum unit, and data at single file arrangement intervals are accessed at high speed.

If an example of each amount of data is shown, in an arbitrary recording medium, a single sector is, for example, 512 Byte, and a plurality of sections which are read at high speed is, for example, 32 KB. Here, a single file arrangement interval in the present example is integral multiple of the capacity of a plurality of sectors (32 KB) which are read at high speed, and the recording data can be read at high speed in a single file arrangement unit.

If it is assumed that a single file arrangement section (a single block) is, for example, 2 MB and a single writing unit is 16 MB, the single writing unit is configured with 8 blocks. Writing can be performed at high speed by causing a single writing unit to coincide with the removal block unit.

The media buffer 58 shown in FIG. 2 has a storage capacity in the single writing unit. These values and the number of blocks correspond to an example.

### [4. Operation of Data Recording Process]

Subsequently, an operation of a data recording process which is performed by the imaging apparatus according to the embodiment will be described with reference to FIGS. 4 and 5.

As shown in FIG. 4, if a process to record video data (record) starts, the CPU 34 which controls recording performs a process to reserve the recording region of a recording medium in step S11. The process to reserve the recording region is performed in a unit of integral multiple of the single writing unit shown in FIG. 3. In order to confirm the reservation, management data is written in the file management information 63 of the recording medium 37 in step S12.

As described above, reservation is made by only writing the management data in the file management information of the recording medium. When only reservation is made, any process is not particularly performed on an actual recording region which is reserved. When there is data which has been written before, the recording region has a state in which the recording data remains.

Thereafter, the CPU 34 which controls recording determines whether or not recording data corresponding to a single writing unit is accumulated in the media buffer 58 in step S13. If, as a result of the determination, it is determined that the recording data corresponding to the single writing unit is accumulated, the CPU 34 transmits the data accumulated in the media buffer 58 to the recording medium 37, and records the data in the file 62 which is the recording unit of the recording medium 37 in step S14. At this time, for example, transmission is sequentially performed to the recording medium 37 from the head data of the media buffer 58, writing is sequentially performed on the recording unit of the recording medium 37 from the head data, and thus the recording data corresponding to the single writing unit is recorded as a single file.

Thereafter, a division process is performed on data which is collectively recorded in a single recording unit for each type of data in step S15. The division process is performed when the file management information which is managed by a file system is written, and the type of data is determined based on data obtained when the recording data is arranged in the media buffer 58. The data division process is performed by the file system control unit 61 shown in FIG. 2, and the file system control unit 61 maintains management data which is not yet written in the file management information 63 of the recording medium 37 at this time and on which the division process is performed.

Subsequently, it is determined whether or not the reserved region of the recording medium 37 is less than predetermined residual quantity and it is necessary to increase the reserved region in step S16. If, as a result of the determination, it is necessary to increase the reserved region, a process to reserve a corresponding region is performed in step S17. The process to reserve a region is performed by the file system control unit 61 shown in FIG. 2, and the file system control unit 61 maintains management data which is not yet written in the file management information 63 of the recording medium 37 at this time and on which the division process is performed.

Thereafter, an update process is performed to collectively record the management data, which is generated in the division process in step S15 and maintained without update, and the management data, which is generated in the process to reserve a region in step S17, in the file management information 63 within the recording medium 37 in step S18. After the update process, the process returns to the process to determine the amount of data in step S13. Meanwhile, details of the process to update the management information in step S18 will be described later.

In addition, if it is determined that the recording data corresponding to the single writing unit is not accumulated in the media buffer 58 in step S13, it is determined whether or not time t₀ which is set in advance has elapsed from immediately before data writing into the recording medium 37 in step S19. It is assumed that the set time t₀ is, for example, 20 seconds.

Further, if it is determined that the time t₀ has elapsed, the process proceeds to step S14, and the data accumulated in the media buffer 58 at this time is written in the side of the recording medium 37. At this time, writing history information data is added to the data which is written.

If the time t₀ has not elapsed from the immediately before the written time in step S19, the process returns to the determination in step S13.

In addition, if it is determined that it is not necessary to increase the reserved region in step S16, the process returns to the determination in step S13. Accordingly, the update of the file management information 63 of the recording medium 37 is collectively performed together with the management data which relates to data which has been written until the update only when the reserved region is increased, and thus the number of updates of the file management information 63 is reduced.

Subsequently, an example of a process to generate the writing history information data will be described with reference to a flowchart in FIG. 5. The generation of the writing history information data is performed by the writing history information generation unit 57 shown in FIG. 2.

As shown in FIG. 5, it is determined whether or not it is time to perform writing on the recording medium 37 in a single writing unit, which is accumulated in the media buffer 58, in step S21. If it is not the time to write, the process waits until it becomes time to write.

Further, if it is determined that it is time to perform writing, it is determined whether or not there is accumulation of data, which is less than the amount of data for single file arrangement, in first additional data and second additional data in step S22.

Here, if there is data which is less than the amount of data for the single file arrangement, the data which is less than the amount of data for the single file arrangement of the first additional data or the second additional data is arranged as the writing history information data in step S23. However, when writing history information which is generated immediately before is arranged for the same first additional data and second additional data, data of the difference between the first additional data and the second additional data of the immediately before writing history information is arranged.

Further, data which indicates the arrangement of various types of data within data in a single writing unit is added as the writing history information data. In addition, data which indicates whether or not version or data is completed is added as the writing history information data as necessary. The writing history information data becomes the amount of data in a single writing unit by adding these data.

Further, the generated writing history information data is supplied to the media buffer 58, and stored in a region at the end of the media buffer 58. In such a way as to arrange the writing history information data at the end of the media buffer 58, when data is transmitted from the media buffer 58 to the recording medium 37, the writing history information is lastly read, and transmitted to and written in the recording medium 37. Accordingly, in a state in which the writing history information is correctly written in the recording medium 37, it is possible to treat each data in a single writing unit, which is written together with the writing history information, as effective data which is correctly written in the recording medium 37.

It is possible to perform restoration when the recording in the recording medium 37 stops due to some reasons in such a way as to use the writing history information which is arranged as described above and written in the recording medium 37. That is, it is possible to determine a region of the reserved region in which data is written based on the writing history information.

### [5. Detailed Example of Data Recording Operation]

Subsequently, a detailed example of a recording operation will be described with reference to FIGS. 6A to 12D.

In each of the drawings in FIGS. 6A to 12D, each of FIGS. 6A, 7A, 8A, 9A, 10A, 11A, and 12A shows data which is input to the recording unit or an accumulation state of data which is generated by the recording unit. In detail, the data corresponds to data accumulated in each of the buffers 52, 53, and 54 in FIG. 2. Main track data is the data of a video/audio multiplex file which is obtained by multiplexing video data and audio data which are main data. The first additional data and the second additional data are previously described additional data, and the writing history information is previously described data which is generated when recording is performed.

In addition, in each of the drawings, each of FIGS. 6B, 7B, 8B, 9B, 10B, 11B, and 12B shows an accumulation state of data of the media buffer 58.

Further, in each of the drawings, each of FIGS. 6C, 7C, 8C, 9C, 100, 11C, and 12C shows a recording state (only a part) of each region of the recording medium 37.

In addition, in each of the drawings, each of FIGS. 6D, 7D, 8D, 9D, 10D, 11D, and 12D shows management data which is written as the file management information.

Each of FIGS. 6A to 12D illustrates an example in which a single recording unit is configured in such a way as to arrange 8 files, and the recording region of the recording medium 37 shows only 8 recording areas M1 to M8. A single recording area M1 includes a storage capacity in which data in a single recording unit is recorded.

In FIGS. 6A to 12D, a state in which each region is empty is a state in which data is not written, and a region which is filled with oblique lines or the like indicates a state in which data is written or a reserved state.

Hereinafter, description will be sequentially made from FIG. 6A.

First, FIGS. 6A to 6D illustrate an example of the reservation process in step S11 and the process to write the reservation information thereof as management data in step S12.

The states in FIGS. 6A to 6D include a state in which input data or generated data are not present as shown in FIG. 6A, and a state in which any data is not accumulated in the media buffer 58 as shown in FIG. 6B. In these states, a plurality of recording areas of a memory card is reserved in advance. In this example, as shown in FIG. 6C, 5 recording areas M1 to M5 are secured as a reserved region R1.

With regard to the reserved region R1, data (data which indicates that the recording areas M1 to M5 are reserved) is stored as the management data in the region of the file management information 63 which is managed by the file system on the side of the recording medium 37 in step S12.

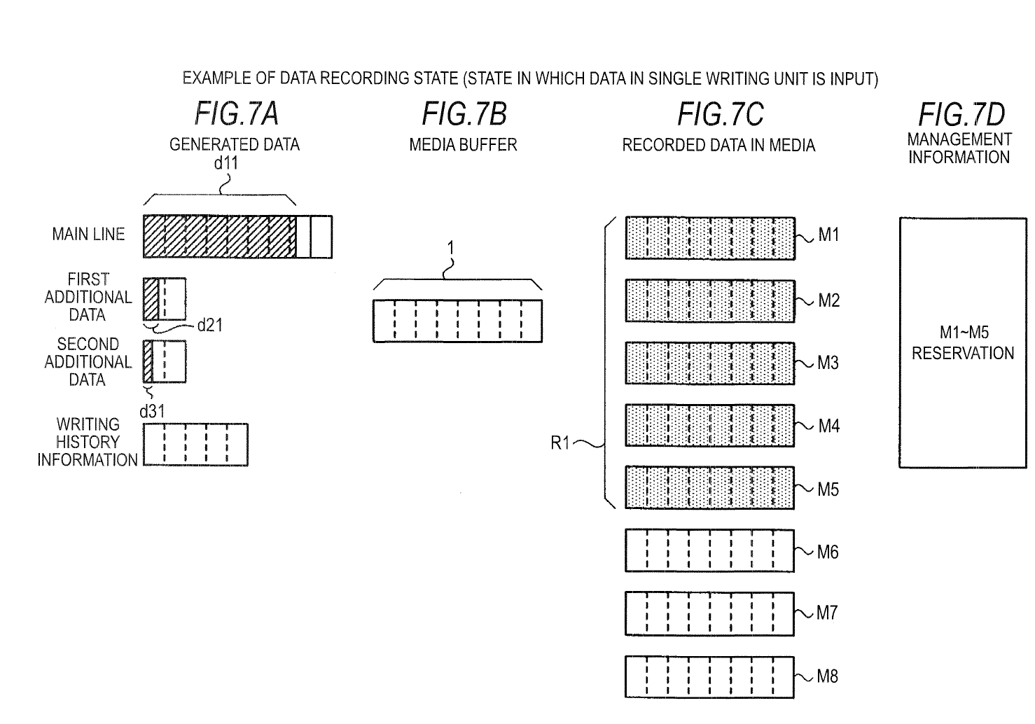

FIGS. 7A to 7D illustrate a state in which data in a single recording unit is input or generated while the reservation shown in FIGS. 6A to 6D is made. Here, FIGS. 7A to 7D illustrate, for example, a state in which main track data d11 corresponding to the amount of data which is greater than 7 file arrangement units is accumulated in the buffer as the main track data (video data and audio data). Each of the amounts of first additional data d21 and second additional data d31 is less than the amount of data in a single recording unit.

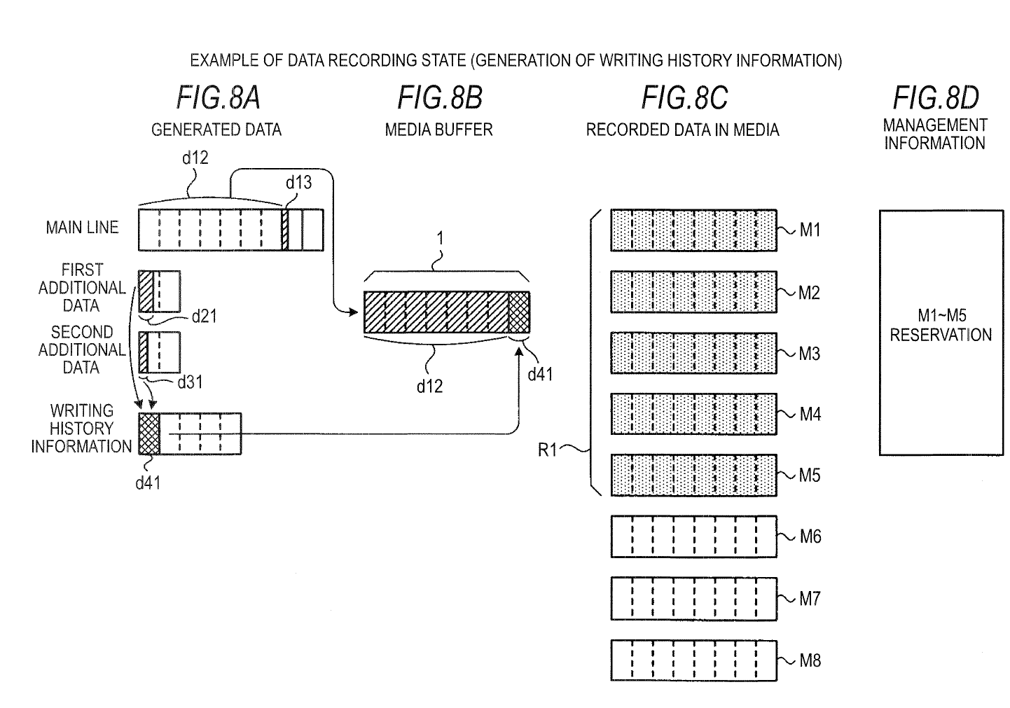

FIGS. 8A to 8D are views illustrating an example of generating the writing history information and writing the writing history information into the media buffer when data shown in FIGS. 7A to 7D are input.

In this state, the first additional data d21 and the second additional data d31, which are less than the amount of data in a single recording unit, are arranged in the writing history information data d41 without change. This arrangement process corresponds to the process in step S23 of the flowchart in FIG. 5. Meanwhile, data which can be omitted in the first additional data d21 and the second additional data d31 may be omitted, and the first additional data d21 and the second additional data d31 may be arranged in the writing history information.

In addition, arrangement data, which indicates each of the data in a file arrangement unit within the data in 8 file arrangement units which are stored in the media buffer 58 is added to the writing history information. This process corresponds to the process in step S24 of the flowchart in FIG. 5. The writing history information data generated in the process until now is set to data having the amount of data in a single file arrangement unit.

Further, as the main track data, for example, the main track data d12 corresponding to 7 file arrangement units within the main track data d11 having the amount of data which is greater than 7 file arrangement units is transmitted to the media buffer 58 and accumulated therein. Further, in a region corresponding to a single file arrangement unit at the end of the media buffer 58, the writing history information data d41 is accumulated. Meanwhile, the main track data d13, which is less than the single file arrangement unit, of the main track data is in a state in which the main track data d13 remains in a video buffer or the like, and the accumulation process is performed without change. The first additional data d21 and the second additional data d31, which are arranged in the writing history information data d41, remain in the respective buffers, and the accumulation process continues without change.

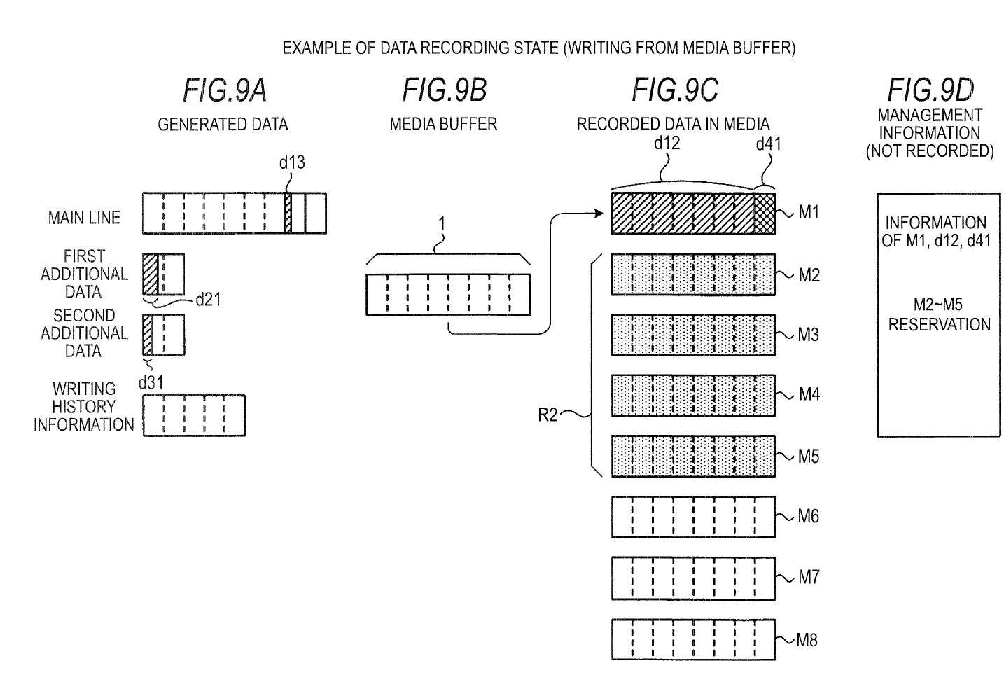

In the process until now, data corresponding to a single recording unit is accumulated in the media buffer 58, and the process moves to a writing process in FIGS. 9A to 9D.

In the writing process in FIGS. 9A to 9D, the data in a single recording unit which is accumulated in the media buffer 58 is sequentially transmitted from the head data in the buffer to the side of the recording medium 37 without change, and recorded in the head area (here, the recording area M1) within the reserved region. A state in which the data is recorded in the recording area M1 is the same as the state in which the data is accumulated in the media buffer 58, the main track data d12 is arranged in the sections of the 7 file arrangement units from the head, and the writing history information data d41 is arranged in a section at the last single file arrangement unit.

If the data recording is performed, it is shown that the main track data d12 and the writing history information data d41 are arranged in the recording area M1 in the management data, as shown in FIG. 9D. In addition, the recording area M1 is changed from the reserved region to a recorded region, and the reserved region R2 is changed into the recording areas M2 to M5. However, the management data which is updated at this time point is maintained within the file system control unit 61 in FIG. 2, and is not yet recorded on the side of the recording medium 37.

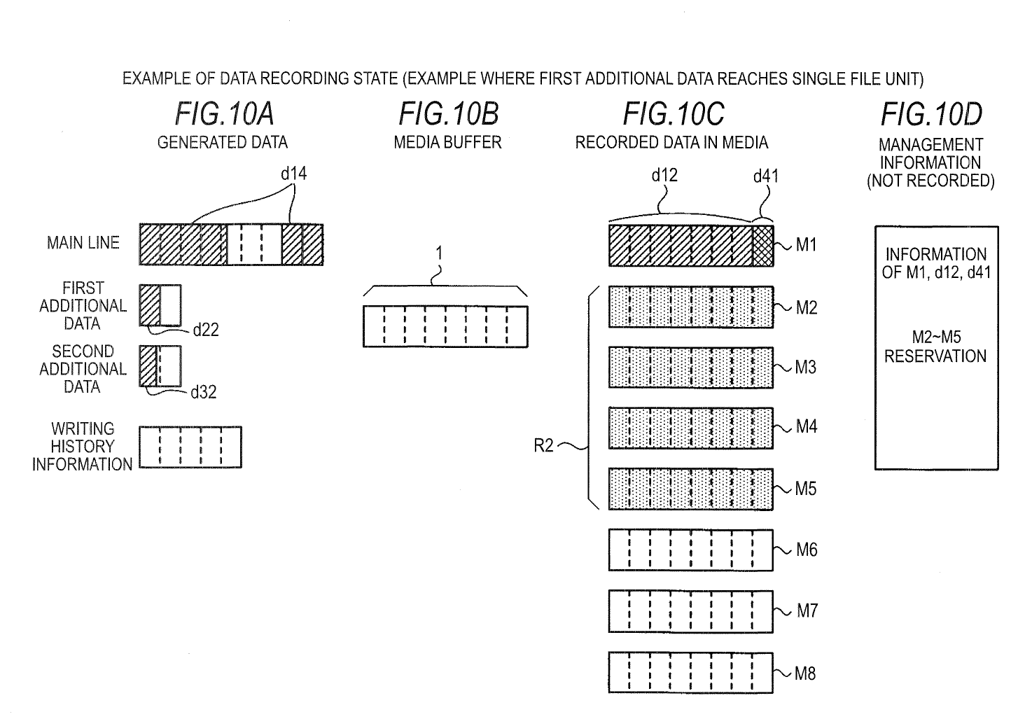

FIGS. 10A to 10D illustrate a state in which data in a single BU, which is a single recording unit, is newly input or generated in a state in which the writing in FIGS. 9A to 9D is performed. Here, a state in which, for example, the main track data d14 having the amount of data which is greater than 6 file arrangement units is accumulated in the buffer as the main track data (the video data and the audio data), as shown in FIGS. 10A to 10D. Meanwhile, a main track buffer shown in FIG. 10A or the like is shown as a ring buffer, and an accumulation position is sequentially changed.

Further, first additional data d22 is in a state in which data in a single file arrangement unit is accumulated. The amount of data in the second additional data d32 is still less than the amount of data in a single file arrangement unit.

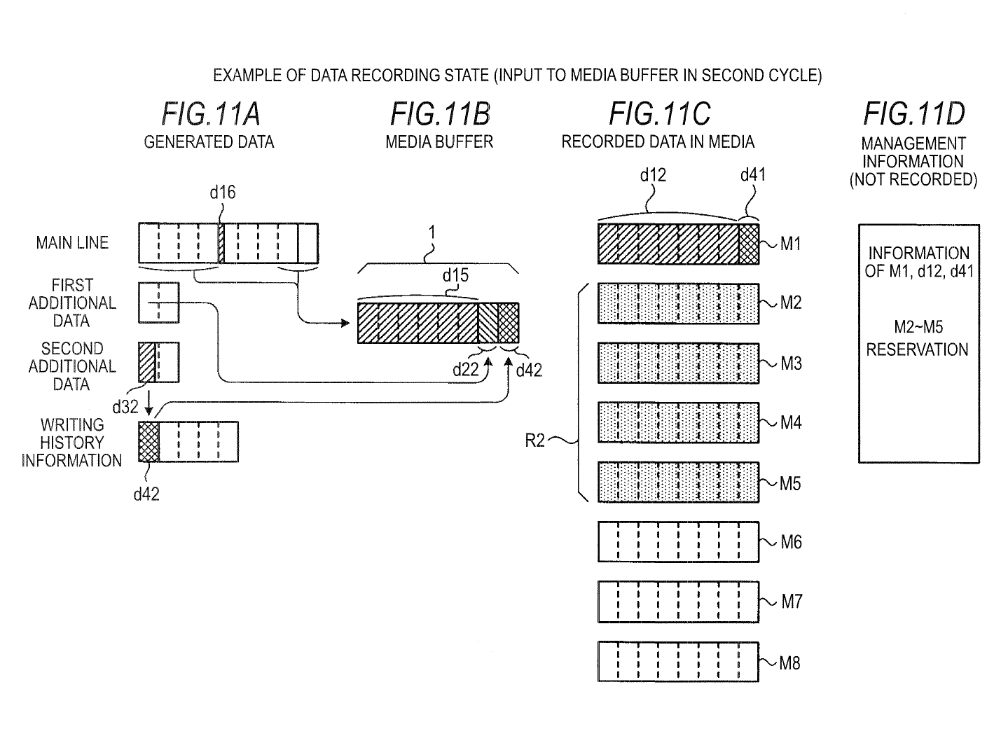

FIGS. 11A to 11D are views illustrating a state in which data is written into the media buffer 58 and a state in which the writing history information is generated when the accumulation is performed in the state of FIGS. 10A to 10D.

In this state, for example, main track data d15 corresponding to 6 file arrangement units within the main track data d14 (FIG. 10A) having the amount of data which is greater than the 6 file arrangement units is transmitted to the media buffer 58 as the main track data, and accumulated therein. In addition, first additional data d22 corresponding to a single file arrangement unit is transmitted to the media buffer 58, and accumulated therein. Further, writing history information data d42 is accumulated in a region corresponding to a single file arrangement unit at the end of the media buffer 58.

In the writing history information data d42, second additional data d32 which is data having the less amount of data in a single file arrangement unit is accumulated. At this time, the differential data between the second additional data d31 and the second additional data d32, which are arranged immediately before writing history information data d41, is arranged as data d42.

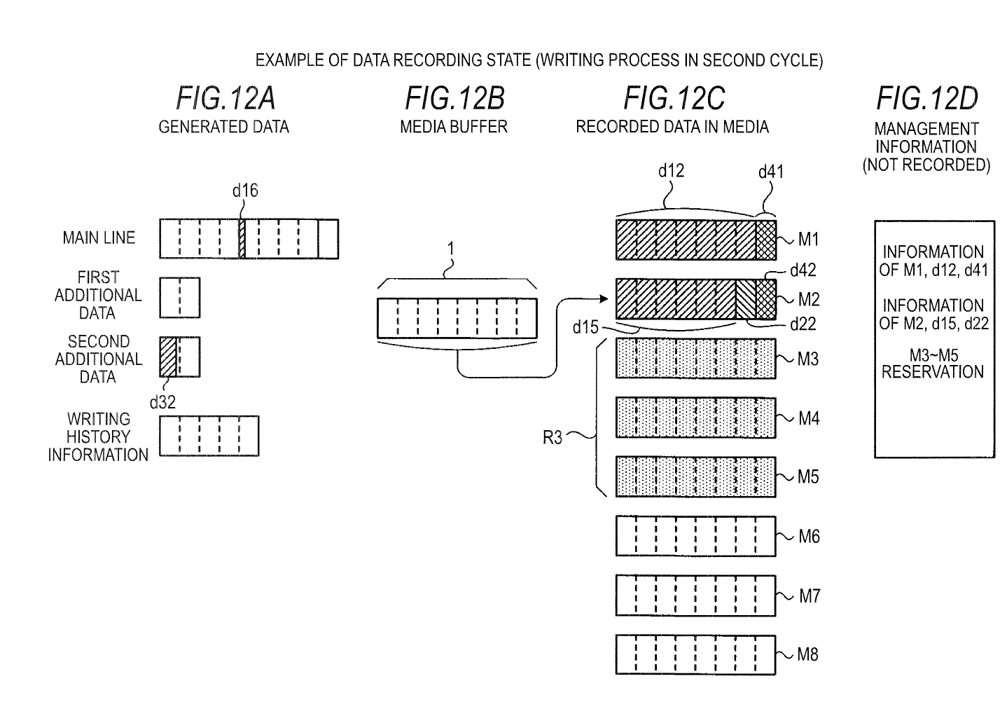

In the process until now, the data corresponding to 8 file arrangement units which are the single recording unit (1 BU) is accumulated in the media buffer 58, and the process moves to a writing process in the second cycle in FIGS. 12A to 12D. Meanwhile, main track data d16 which is less than a single file arrangement unit and second additional data d32 which is less than a single file arrangement unit remain in the respective data buffers, and the remained data continues to be accumulated without change.

In the writing process in FIGS. 12A to 12D, the data in a single recording unit which is accumulated in the media buffer 58 is sequentially transmitted from the head data of the buffer to the side of the recording medium 37 without change, and recorded in a head area (here, the recording area M2) which is empty within the reserved region. A state in which the data is recorded in the recording area M2 is the same as a state in which the data is accumulated in the media buffer 58. The main track data d15 is arranged in the sections of the 6 file arrangement units from the head, the first additional data d22 is arranged in the section of a subsequent single file arrangement unit, and the writing history information data d42 is arranged in the section of a last single file arrangement unit.

If the data is recorded, as shown in FIG. 12D, the main track data d12 and the writing history information data d41 are arranged in the recording area M2 of the management data. In addition, the recording area M2 is changed from the reserved region to a recorded region, and the reserved region R3 is changed into the recording areas M3 to M5. Even in this time point, the updated management data is maintained in the file system control unit 61 in FIG. 2, and is not yet recorded on the side of the recording medium 37.

Further, when the reserved region changes and the residual quantity of the reserved region is equal to or less than a predetermined quantity, a process to extend the reserved region is performed. The process to extend the reserved region is performed in step S17 of the flowchart in FIG. 4. Thereafter, the management data which extends the reserved region and the management data which is the result of division performed in step S15 are recorded at once in the file management information 63 on the side of the recording medium 37 at the same time in step S18.

### [6. Example of Division Performed on Management Data]

Subsequently, a detailed example of the data division process which is performed in step S15 of the flowchart in FIG. 4 will be described with reference to FIGS. 13A to 14B. Here, a process is performed to set a single data of a continuous region in which a group of video data and audio data are recorded on the recording medium to management data obtained by performing division on the management data.

In the example in FIGS. 13A and 13B, FIG. 13A shows a recording state in each area of the recording medium, and FIG. 13B shows a generation state of the management data. However, in the state in FIG. 13B, a state is shown in which only the management data is generated and the generated data is not recorded in the file management information 63 of the recording medium 37 (FIG. 2).

In this example, as shown in FIG. 13A, a state is shown in which data is recorded in three recording areas M1, M2, and M3, and the main track data d11, d12, and d13, the first additional data d21 and d22, and the second additional data d31 are divided into three areas and recorded therein. The recording in the three recording areas M1, M2, and M3 is performed in order that the data is generated as shown in FIGS. 6A to 12D.

At this time, it is assumed that a recording address (the recording region) in which the last writing history information data d41, d42, and d43 of each of the recording areas M1, M2, and M3 is located is collective data as the management data D40 of a single piece of writing history information.

In addition, a recording address in which the main track data d11, d12, and d13 are recorded is determined based on information obtained when control is performed such that each data is arranged in the media buffer 58. Further, management data D10 which indicates the recording address or the like of the main track data d11, d12, and d13 is generated.

Similarly, in addition, a recording address in which the first additional data d21 and d22 is recorded is determined based on the information obtained when control is performed such that each data is arranged in the media buffer 58, and management data D20 which indicates the recording address or the like of the first additional data d21 and d22 is generated.

Further, in addition, a recording address or the like in which the second additional data d31 is recorded is determined based on the information obtained when control is performed such that each data is arranged in the media buffer 58, and management data D30 which indicates the recording address of the second additional data d31 is generated.

In the state shown in FIGS. 13A and 13B, the management data is only generated, the process in step S15 of the flowchart in FIG. 4 is performed, and the management data is not yet recorded as the file management information 63 of the recording medium 37.

Subsequently, the processes in steps S16 and S17 of the flowchart in FIG. 4 are performed, and the process moves to a process in a state shown in FIGS. 14A and 14B.

That is, first, as shown in step S16 of the flowchart in FIG. 4, the necessary amount of data (here, 5 file arrangement units) is secured as the reserved region. Therefore, the recording areas M6, M7, and M8 are newly set to the reserved regions, and the fact is indicated by the management data.

Further, as the process in step S17 of the flowchart in FIG. 4, the management data which is generated in the process shown in FIGS. 13A and 13B and the management data with regard to the recording areas M6, M7, and M8 which are newly set to the reserved regions, that is, the management data shown in FIGS. 14A and 14B are collectively written. That is, the file management information 63 of the recording medium 37 is set to the management data shown in FIGS. 14A and 14B.

As described above, according to the imaging apparatus according to the embodiment, the video data and the audio data, which are captured and generated, and the additional data thereof are written on the side of the memory cared in order of generation (input) in the buffer in a state in which the respective data are mixed in file configuration units. Therefore, when writing is performed, the delay of data is controlled to the minimum between the recording apparatus (the imaging apparatus) and the recording medium, and the data is written into the recording medium for each single recording unit. Accordingly, even when unexpected stop, such as power interruption or the like, occurs in the middle of writing, it is possible to suppress data which is not recorded in the recording medium to minimum, and it is possible to cause the loss of data which is being captured and recorded in the recording medium to be a minimum when any trouble occurs.

Further, after writing is performed into the recording medium, the management data is updated, and thus the management data is treated as data which is continuous for each type on file management. Accordingly, when reproduction is performed, excellent and rapid reproduction using the management data is performed.

In addition, when data is transmitted from the media buffer 58 to the recording medium 73 and recorded therein, the writing history information data is added to each data in a single recording unit, which is notification data. Therefore, it is possible to restore the additional data with regard to the recorded video data and audio data based on the writing history information data. That is, since the first additional data or the second additional data which is less than the file configuration unit is added to the writing history information data, the additional data is restored even when the recording operation stops while the first additional data or the second additional data is not recorded on the side of the memory card as original data.

### [7. Example of Process to Update Management Information]

Subsequently, the process to update the management information which is performed on the side of the recording medium by the imaging apparatus according to the embodiment will be described in detail with reference to FIGS. 15 to 19.

This example is an example in which the file management information 63 of the file system on the side of the recording medium 37 is applied as update information. In the embodiment, before the file management information 63 of the file system is updated, the video data and/or audio data which is the main data accumulated in the stream buffer 71 is appropriately expelled into the recording medium 37.

FIG. 15 is a flowchart illustrating an example of a process to update the file management information according to the embodiment.

First, when an operation of the process to update the file system of the recording medium 37 starts, the CPU 34 which controls recording (refer to FIG. 1) determines whether or not it is time to update the file management information 63 of the file system on the side of the recording medium 37 in step S31. In a case in which it is not the time to perform update, the CPU 34 waits until it is the time to perform update.

Further, when it is determined that it is the time to perform update, the stream buffer monitoring unit 72 monitors the free space of the stream buffer 71, and notifies the file system control unit 61 of the free space in step S32.

The file system control unit 61 compares the free space of the stream buffer 71 which is notified by the stream buffer monitoring unit 72 with the amount of data (threshold) corresponding to time which is necessary to update the file management information 63 in step S33.

For example, there is a method of calculating the free space of the stream buffer 71 which is necessary to update the update information in advance, and maintaining the free space in the file system control unit 61 or the ROM 35. Or, there is a method of dynamically calculating the free space using the kind of the recording medium 37, a processing speed, and an access pattern for the update of the file system. It is possible to confirm the access pattern when, for example, stream data is written into the recording medium 37.

After the comparison process is performed in step S32, the file system control unit 61 determines whether or not the free space of the stream buffer 71 is sufficient to update the file management information 63 in step S34. Here, when it is determined that the free space of the stream buffer 71 is sufficient, the file system control unit 61 instructs the file recording processing unit 59 to directly update the file management information 63. The file recording processing unit 59 receives the instruction from the file system control unit 61, and updates the file management information 63 on the side of the recording medium 37 in step S35.

Besides, when it is determined that the free space of the stream buffer 71 is not sufficient in the determination process in step S34, the file system control unit 61 once defers the update of the file management information 63 on the side of the recording medium 37 performed by the file recording processing unit 59 in step S36. Further, during this period, the stream data (the video data and the audio data) which is accumulated in the stream buffer 71 is written into the recording medium 37 in step S37. After this process ends, the process returns to the process in step S32.

Further, the file system control unit 61 performs the processes in steps S32 to S34 again, compares the free space of the stream buffer 71 with the amount of data corresponding to time which is necessary to update the file management information 63, and determines the over and short of the free space. Here, when it is determined that the free space of the stream buffer 71 is sufficient, the file recording processing unit 59 updates the file management information 63. When it is determined that the free space of the stream buffer 71 is not sufficient, processes in steps S36 and S37 are performed.

In the above-described present embodiment, when there is not a free space in the stream buffer to store the stream data corresponding to the time which is necessary to update the file management information, the update of the file management information is deferred once. Further, until the free space corresponding to the time which is necessary to perform update can be secured in the stream buffer, data in the stream buffer is previously written into the recording medium, and then the file management information is updated.

That is, time to update the file management information of the file system within the recording medium is adjusted based on the free space in the stream buffer of an apparatus, such as an imaging apparatus. In addition, it is possible to write the stream data and update the file management information without generating buffer overflow.

For example, it is suitable to apply when using a low-speed recording medium which takes time to update the management information, a system which has small stream buffer capacity, and a format which has the large amount of generated stream data. Since it is easy to store data in the stream buffer in these forms, it is possible to certainly secure the free space corresponding to the time which is necessary to update the file management information by applying the technology according to the present disclosure.

### (First Example of Update Process)

Hereinafter, an example of writing into the recording medium 37 when recording of cache recording starts will be described as the first example of the process to update the above-described file management information.

The cache recording is that stream data from an imaging apparatus is repeatedly recorded in a cache memory (corresponds to the stream buffer 71 in the present example), and the stream data which is recorded in the cache memory is written into the recording medium when recording starts. Therefore, it is possible to retroactively back-record a predetermined time from the present. Meanwhile, since the file management information is updated when a file system (FS) is being synchronized, time that the file management information is being updated may be written as FS synchronization in the description below.

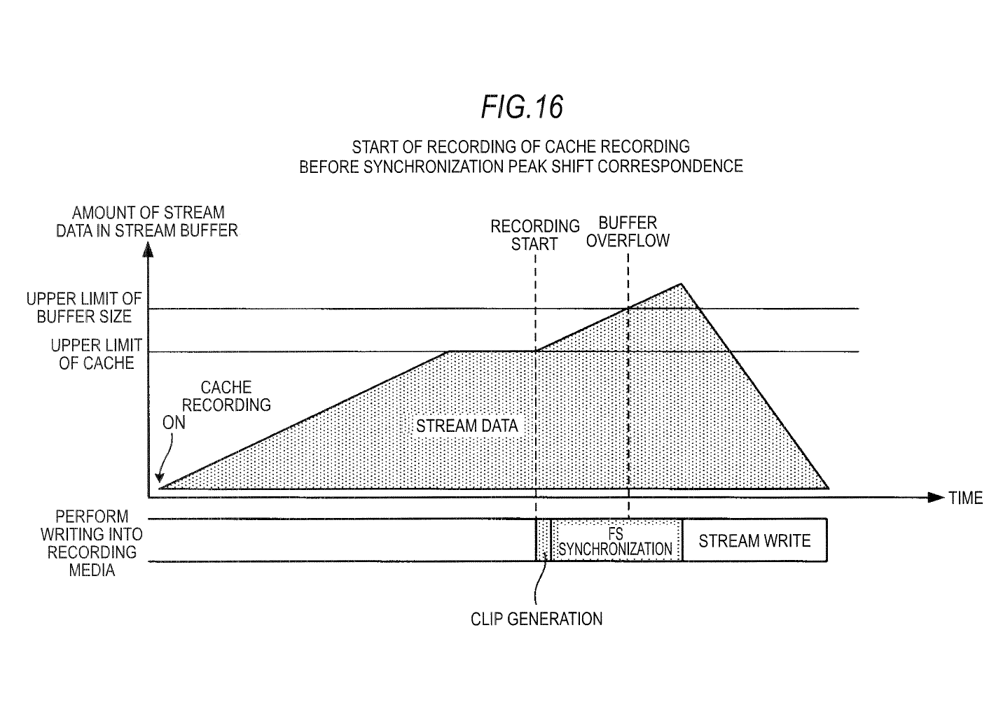

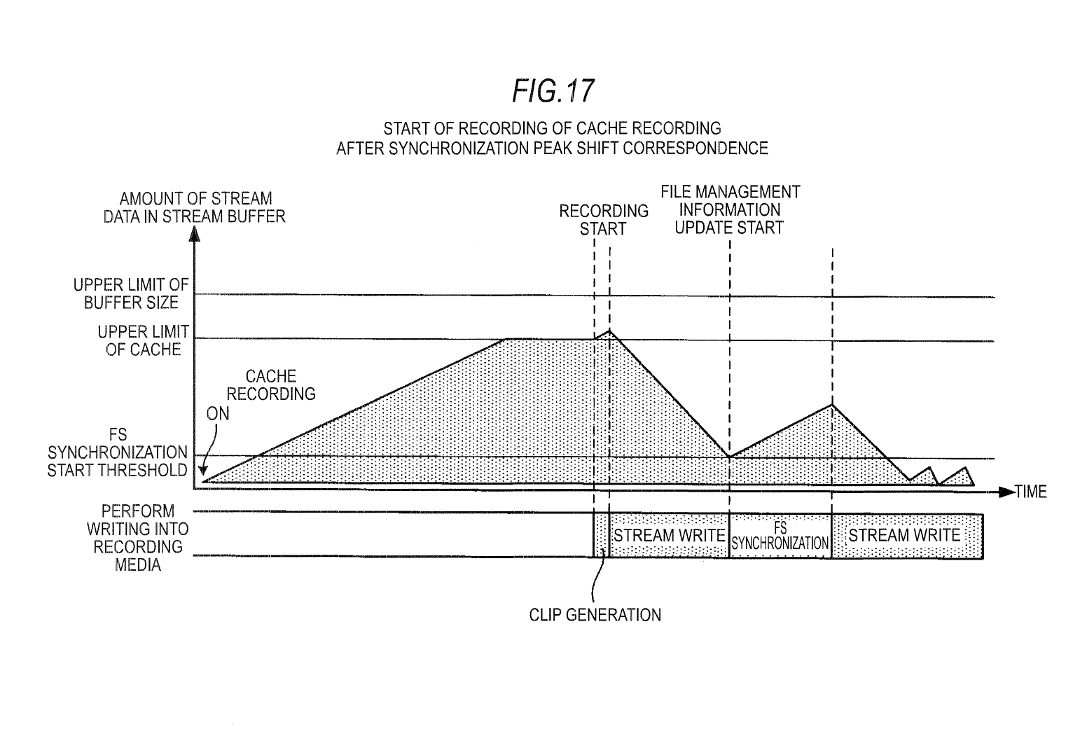

FIG. 16 is a view illustrating an example in which writing is performed into the recording medium 37 when the recording starts in the cache recording according to the related art (before synchronization peak shift correspondence). In a graph in FIG. 16, a horizontal axis indicates time, and a vertical axis indicates the stream data within the stream buffer. A horizontal axis and a vertical axis in a graph in FIG. 17 which will be described later are the same.

As shown in FIG. 16, the writing performed into the recording medium 37 until now is a flow in which the stream data is accumulated in the stream buffer 71 between clip generation (clip information writing) and the file management information update (confirming), and the stream data is written after the update of the file management information is completed. As described above, after the cache recording starts, the clip generation process and the file management information update are all completed, and then the stream data which is accumulated in the stream buffer 71 is written.

In this case, when the file management information is being updated (during the FS synchronization), it is not possible to write the stream data, and thus the data is stored in the stream buffer 71. If it takes time to write the file management information, buffer overflow which exceeds the upper limit of a buffer size occurs, and thus abnormally recording ends.

Here, the clip information is metadata which is related to the generated clip. The clip information is managed by, for example, a file which is used to collectively manage a plurality of clips, and a file which is used to mange video data or audio data which configures a clip for each clip.

An example of writing into the recording medium in the cache recording (after synchronization peak shift correspondence) according to an embodiment of the present disclosure when recording starts will be described with reference to FIG. 17.

In the embodiment, as shown in FIG. 17, the stream buffer monitoring unit 72 checks the free space of the stream buffer 71 in a process to generate a clip. The file system control unit 61 writes the stream data into the recording medium 37 from the stream buffer 71 in advance until a free space which is necessary to update the file management information is secured. Further, the file system control unit 61 decreases the amount of data of the stream buffer 71 up to an FS synchronization onset threshold, secures sufficient free space in the stream buffer 71, and then the file recording processing unit 59 starts to update the file management information.

As described above, it is possible to prepare a space enough to store stream data, which is generated when the file management information is being updated (when the FS synchronization is being performed), in the stream buffer 71 (synchronization peak shift) by writing the stream data from an appropriate stream buffer 71 before the file management information is updated. Therefore, it is possible to write the stream data and update the file management information without generating the buffer overflow.

Meanwhile, in the example shown in FIG. 17, a clip is generated (clip information is written) before the stream data is written into the recording medium 37 from the stream buffer 71 in order to secure the free space which is necessary to update the file management information. The time that is necessary to writ the clip information which is one of the management information is shorter than time to process the FS synchronization when the file management information is updated. As described above, the writing of the clip information may be first completed using the free space of the stream buffer 71 at a current time point. In addition, it is possible to directly move the process to the process to update the file management information after sufficient free space is secured in the stream buffer 71 by writing the clip information before the stream data is written.

It is apparent that the process may be performed in order of the writing of the stream data, the writing of the clip information, and the update of the file management information according to the process in FIG. 15.

### (Second Example of Update Process)

Subsequently, as a second example of the above-described process to update the file management information, an example of writing into the recording medium when recording starts in media stride will be described.

The stream buffer 71 may use, as an example, a ring buffer which includes two buffers. The media stride is, for example, to convert the recording destination of the stream data from one buffer (stride source) within the stream buffer 71 into another buffer (stride destination). The media stride is also called slot stride.

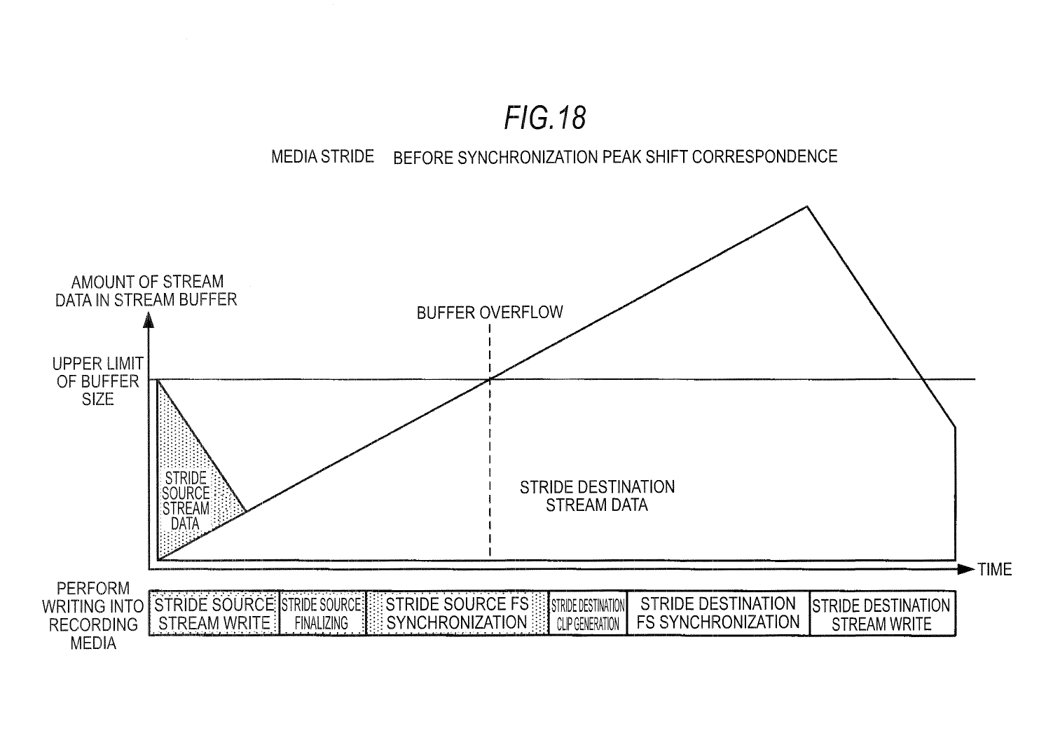

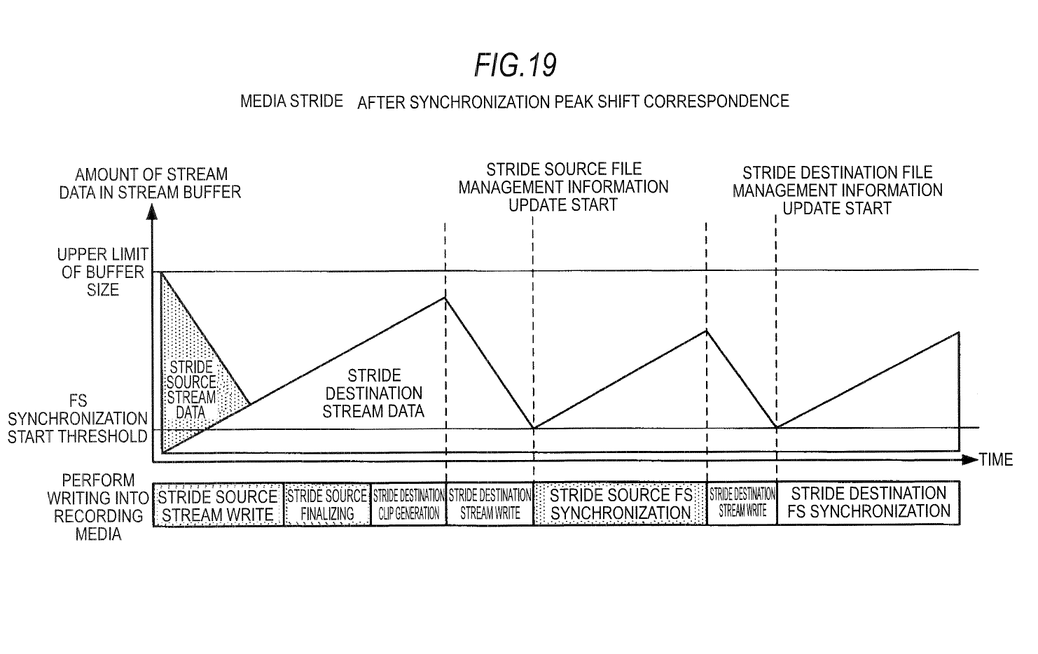

FIG. 18 is a view illustrating an example of writing into the recording medium in the media stride (before the synchronization peak shift correspondence) according to the related art. A horizontal axis in a graph in FIG. 18 indicates time, and a vertical axis indicates the amount of stream data within the stream buffer. A horizontal axis and a vertical axis in a graph in FIG. 19 which will be described later are the same.

As shown in FIG. 18, the writing into the recording medium 37 until now is first to accumulate stride destination stream data into the stream buffer 71 during the writing of the finalized data of a stride source clip, the update of stride source file management information, the generation of stride destination clip (the writing of the clip information), and the update (confirming) of stride destination file management information. Further, the flow is that the stream data is written after the update of the file management information 63 is completed. As described above, in the media stride, after the update (confirming) of the management information of the stride source and the management information of the stride destination is updated is completed, the stride destination stream data which is accumulated in the stream buffer 71 is written.

In this case, when the stride process is being performed, the stream data is not written, and thus data is stored in the stream buffer 71. As the same as the cache recording in the first example, if it takes time to write the file management information, the upper limit of a buffer size is exceeded and the buffer overflow occurs, and thus the abnormal recording ends.

An example of writing into the recording medium in the media stride (after the synchronization peak shift correspondence) according to an embodiment of the present disclosure will be described with reference to FIG. 19.

In the embodiment, as shown in FIG. 19, the stream buffer monitoring unit 72 checks the free space of the stream buffer 71 in the stride process. The file system control unit 61 first writes the stride destination stream data from the stream buffer 71 to the recording medium 37 until a free space which is necessary to update the file management information is secured. Further, the file system control unit 61 decreases the amount of data in the stream buffer 71 up to the FS synchronization onset threshold, and secures a sufficient free space in the stream buffer 71, and then the file recording processing unit 59 starts to update the file management information.

As described above, it is possible to prepare a space enough to store stream data, which is generated when the stride destination file management information is being updated (when the FS synchronization is being performed), in the stream buffer 71 (synchronization peak shift) by writing the stride destination stream data from the appropriate stream buffer 71 before the stride destination file management information is updated. Therefore, it is possible to write the stride destination stream data and update the destination file management information without generating the buffer overflow.

Meanwhile, in the example shown in FIG. 19, a stride destination clip is generated (stride destination clip information is written) before the stride destination stream data is written into the recording medium 37 from the stream buffer 71 in order to secure the free space which is necessary to update the stride source file management information. The time that is necessary to write the stride destination clip information which is one of the management information is shorter than the time to process the FS synchronization when the stride destination file management information is updated. Accordingly, as the same as the example in FIG. 17, the writing of the stride destination clip information may be first completed using the free space of the stream buffer 71 at current time point. In addition, it is possible to directly move the process to the process to update the stride destination file management information immediately after sufficient free space is secured in the stream buffer 71 by writing the stride destination clip information before the stride destination stream data is written.

It is apparent that the process may be performed in order of the writing of the stride destination stream data, the writing of the stride destination clip information, and the update of the stride destination file management information according to the process in FIG. 15.

As described with reference to the first and second examples, the free space of the stream buffer is first checked at time that the file management information of the file system is updated. Further, when the free space is less than a set threshold (the amount of data corresponding to time which is necessary to update at least file management information), the update of the file management information is delayed, the stream data within the stream buffer is first written, and then the file management information is updated. Therefore, it is possible to avoid buffer overflow.

### (Details)

For example, it is assumed that the amount of stream data which is stored in the stream buffer corresponds to a seconds. If a margin corresponding to b seconds is considered, the maximum value of time which is assigned to an FS synchronization time is (a−b) seconds.

At FS synchronization time that recording starts, that recording is being performed, or that recording is finalized, the free space of the stream buffer is checked. As an example, when there is a free space which is equal to or greater than (a−b) seconds, the FS synchronization is first performed in the same manner as before.

Besides, when the free space of the stream buffer is less than the (a−b) seconds, the FS synchronization is performed after the stream data is written until a free space which is equal to or greater than the (a−b) seconds is generated.

Although the free space of the stream buffer which starts the FS synchronization is set to a fixed value at this time, there is a method of dynamically changing the free space of the stream buffer depending on the speed of the recording medium. The speed of the recording medium may be obtained by reading the data from the recording medium. Otherwise, there is a method of obtaining the speed of the recording medium by actually writing the stream data in the recording medium.

In the cache recording which is the above-described first example, when the cache recording starts at a state in which the stream data is accumulated in the stream buffer during the time that is equal to or greater than the (a−b) seconds, the flow is made in order of clip generation (clip information writing)→stream data writing until the free space is generated during the time that is equal to or greater than the (a−b) seconds→stride destination FS synchronization.

In addition, if the media stride which is the second example is applied, when there is not a free space in the stream buffer, the flow is made in order of stride source clip finalizing→stride destination clip generation (clip information writing)→stride destination stream data writing until the free space is generated during time that is equal to or greater than the (a−b) seconds→FS synchronization.

Meanwhile, the example of the writing into the recording medium when the recording starts in the cache recording has been described as the first example of the process when the file management information is updated. The example of the writing into the recording medium when the recording starts in the media stride has been described as the second example. However, the present disclosure is not limited thereto.

For example, when a user repeatedly hits a recording button provided in an imaging apparatus, new stream data is generated at short intervals, and thus stream data is sequentially accumulated in the stream buffer. Here, it is preferable to secure the free space by writing the data which is accumulated in the stream buffer before the file management information is updated by applying the technology according to the present disclosure. In addition, the technology according to the present disclosure may be applied when the file management information is updated at a normal state, and it is possible to avoid buffer overflow as the same as the above-described examples.

In addition, it is possible to apply the technology according to the present disclosure with regard to the FS synchronization process when the process to confirm the reservation of a region in step S12 in FIG. 4 is performed. For example, it is possible to avoid buffer overflow in the FS synchronization process when the writing performance of the recording medium is temporarily deteriorated for some reason and when the reservation of the region obtained after the stream data is stored in the stream buffer is confirmed.

In addition, although the media stride has been described as an example in the above-described second example, there are clip stride, FS stride and the like. The clip stride is a stride process between clips. In addition, the FS stride is a stride process between file system management units. As described above, the second example maybe a stride process between both physical and logical recording regions.

### [8. Modification Example]

Meanwhile, in the embodiments which have been described until now, the configuration and the processing operation of the recording apparatus are embedded in an imaging apparatus which is a video camera. However, it is possible to apply the present disclosure to various types of recording apparatuses in addition thereto. That is, the same recording process may be applied to a recording apparatus, which records video data and audio data in a recording medium, in addition to the imaging apparatus. Otherwise, it is possible to apply the present disclosure to a recording apparatus which records main data in addition to the video data and the audio data and the additional data of the main data at the same time.

In addition, with regard to the detailed data arrangement states shown in FIGS. 6A to 14B, data arrangement which illustrates the principle of the embodiments and which is different from the arrangement in the drawings may be used.

In addition, in addition to a case in which a dedicated recording apparatus having each purpose, such as the imaging apparatus shown in FIG. 1, is configured to perform the process according to the embodiment of the present disclosure, the present disclosure may be applied to an information processing apparatus (system) which is configured with, for example, a personal computer apparatus and the peripheral devices thereof. That is, by installing a program (software) which performs a process according to the embodiment of the present disclosure in a personal computer apparatus, and executing the program, each data may be recorded in a recording medium or the like on the computer apparatus in the same manner.

In addition, the above-described data configuration of the recording data, such as the writing history information or the like, has been illustrated as an example, and the other configuration may be used. The data arrangement is illustrated as a preferable example, and the other data arrangement may be used.

The present disclosure may also be configured as follows.)

(1) A recording apparatus including a buffer unit that accumulates input stream data; a file recording processing unit that records a file of the stream data which is accumulated in the buffer unit and management information which is used to manage the file in a recording medium; a buffer monitoring unit that monitors a free space of the buffer unit; and a file system control unit that controls time that updates the management information using the file recording processing unit based on the free space of the buffer unit which is notified by the buffer monitoring unit.

(2) In the recording apparatus of (1), the file system control unit compares the free space of the buffer unit which is notified by the buffer monitoring unit with an amount of data corresponding to time that is necessary to update the management information, when the free space of the buffer unit is less than the amount of data corresponding to the time that is necessary to update the management information, controls the file recording processing unit, and records the stream data which is accumulated in the buffer unit in the recording medium.

(3) In the recording apparatus of (2), after recording the stream data which is accumulated in the buffer unit in the recording medium, the file system control unit updates the management information of the recording medium in the file recording processing unit after the free space of the buffer unit is greater than the amount of data corresponding to the time that is necessary to update the management information.

(4) In the recording apparatus of (3), when cache recording starts and the free space of the buffer unit is less than the amount of data corresponding to the time that is necessary to update the management information, the file system control unit controls the file recording processing unit such that the stream data which is accumulated in the buffer unit is recorded in the recording medium.

(5) In the recording apparatus of (3), when the stream data is recorded between one recording region and another recording region in a stride manner and when the free space of the buffer unit is less than the amount of data corresponding to the time that is necessary to update the management information, the file system control unit controls the file recording processing unit such that the stream data which is accumulated in the buffer unit is recorded in the recording medium.

(6) An imaging and recording apparatus including: an imaging unit; a buffer unit that accumulates stream data which is supplied from the imaging unit; a file recording processing unit that records a file of the stream data which is accumulated in the buffer unit and management information which is used to manage the file in a recording medium; a buffer monitoring unit that monitors a free space of the buffer unit; and a file system control unit that controls time that updates the management information using the file recording processing unit based on the free space of the buffer unit which is notified by the buffer monitoring unit.

(7) A recording method including: accumulating input stream data in a buffer unit; monitoring a free space of the buffer unit by a buffer monitoring unit; and controlling time that updates the management information about a file recorded in a recording medium based on the free space of the buffer unit, which is notified by the buffer monitoring unit, by a file system control unit.

(8) A program causing a computer to perform a process including: accumulating input stream data in a buffer unit; monitoring a free space of the buffer unit using a buffer monitoring unit; and controlling time that updates the management information about a file recorded in a recording medium based on the free space of the buffer unit, which is notified by the buffer monitoring unit, by a file system control unit.

The present disclosure contains subject matter related to that disclosed in Japanese Priority Patent Application JP 2012-096968 filed in the Japan Patent Office on Apr. 20, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A recording apparatus comprising:
a buffer unit that accumulates input stream data;
a file recording processing unit that records a file of the stream data which is accumulated in the buffer unit and management information which is used to manage the file in a recording medium;
a buffer monitoring unit that monitors a free space of the buffer unit; and
a file system control unit that controls time that updates the management information using the file recording processing unit based on the free space of the buffer unit which is notified by the buffer monitoring unit.

2. The recording apparatus according to claim 1,
wherein the file system control unit compares the free space of the buffer unit which is notified by the buffer monitoring unit with an amount of data corresponding to time that is necessary to update the management information, when the free space of the buffer unit is less than the amount of data corresponding to the time that is necessary to update the management information, controls the file recording processing unit, and records the stream data which is accumulated in the buffer unit in the recording medium.

3. The recording apparatus according to claim 2,
wherein, after recording the stream data which is accumulated in the buffer unit in the recording medium, the file system control unit updates the management information of the recording medium in the file recording processing unit after the free space of the buffer unit is greater than the amount of data corresponding to the time that is necessary to update the management information.

4. The recording apparatus according to claim 3,
wherein, when cache recording starts and the free space of the buffer unit is less than the amount of data corresponding to the time that is necessary to update the management information, the file system control unit controls the file recording processing unit such that the stream data which is accumulated in the buffer unit is recorded in the recording medium.

5. The recording apparatus according to claim 3,
wherein, when the stream data is recorded between one recording region and another recording region in a stride manner and when the free space of the buffer unit is less than the amount of data corresponding to the time that is necessary to update the management information, the file system control unit controls the file recording processing unit such that the stream data which is accumulated in the buffer unit is recorded in the recording medium.

6. An imaging and recording apparatus comprising:
an imaging unit;
a buffer unit that accumulates stream data which is supplied from the imaging unit;
a file recording processing unit that records a file of the stream data which is accumulated in the buffer unit and management information which is used to manage the file in a recording medium;
a buffer monitoring unit that monitors a free space of the buffer unit; and
a file system control unit that controls time that updates the management information using the file recording processing unit based on the free space of the buffer unit which is notified by the buffer monitoring unit.

7. A recording method comprising:
accumulating input stream data in a buffer unit;
monitoring a free space of the buffer unit by a buffer monitoring unit; and
controlling time that updates the management information about a file recorded in a recording medium based on the free space of the buffer unit, which is notified by the buffer monitoring unit, by a file system control unit.

8. A program causing a computer to perform a process comprising:
accumulating input stream data in a buffer unit;
monitoring a free space of the buffer unit using a buffer monitoring unit; and
controlling time that updates the management information about a file recorded in a recording medium based on the free space of the buffer unit, which is notified by the buffer monitoring unit, by a file system control unit.
